(19) United States
(12) Patent Application Publication
(10) Pub. No.: US 2008/0305369 A1
(43) Pub. Date: Dec. 11, 2008

(54) Fuel Cell Operating Method and Apparatus For the Same

(76) Inventors: Tatsuya Muraki, Kanagawa (JP); Katuhiro Terao, Kanagawa (JP); Tetsunari Nakamura, Kanagawa (JP); Taro Aoki, Kanagawa (JP); Tadahiro Hyakudome, Kanagawa (JP); Syojiro Ishibashi, Kanagawa (JP)

Correspondence Address: WENDEROTH, LIND & PONACK, L.L.P., 2033 K STREET N. W., SUITE 800, WASHINGTON, DC, 20006-1021, US

(21) Appl. No.: 11/630,107

(22) PCT Filed: Feb. 7, 2006
(86) PCT No.: PCT/JP2006/302040

§ 371 Date: Dec. 20, 2006

(30) Foreign Application Priority Data
Feb. 14, 2005 (JP) 2005-035360

(51) Int. Cl. H01M 8/00

(52) U.S. Cl. 429/13

(57) ABSTRACT

There is a problem in that a gas pressure in an oxygen container of an oxygen supply device is high, thereby causing a mounting cost for charging gas into the oxygen container. Further, there is also a problem in terms of safety at a time of operation. A hydrogen occluding alloy container (5) containing a hydrogen occluding alloy which occludes the hydrogen is used as a hydrogen resource, an oxygen storage container (4b) containing an oxygen adsorbing material (23) that adsorbs the oxygen is used as an oxygen resource, a hydrogen heating means (11a) for heating the hydrogen occluding alloy container (5) and an oxygen heating means (11b) for heating the oxygen storage container (4b) are provided, and the hydrogen occluding alloy container (5) is heated by the hydrogen heating means (11a) and an excess exhaust heat obtained after the hydrogen occluded in the hydrogen occluding alloy is emitted is guided to the oxygen heating means (11b) to heat the oxygen storage container (4b), thereby promoting removal of the oxygen from the oxygen adsorbing material (23) and allowing a pressure of an oxygen gas to rise to supply the hydrogen and the oxygen to the fuel cell (1).

### TECHNICAL FIELD

The present invention relates to a fuel cell operating method and an apparatus for the same.

### BACKGROUND ART

As a conventional fuel cell operating apparatus, there is known one disclosed in Patent Document 1.

That is, in the fuel cell operating apparatus including a cooling system for absorbing thermal energy generated from a fuel cell by circulating a cooling medium, the cooling system is structured as a closed circuit, the thermal energy generated from the fuel cell is recovered by a heat exchanger provided to the cooling system, and there is provided control means for adjusting a heat exchange amount of the heat exchanger according to temperature or a pressure of the cooling medium.

Further, there is also known one in which hydrogen consumed in the fuel cell is occluded by a hydrogen occluding alloy in a hydrogen occluding alloy container (e.g., Patent Document 2).

That is, cooling water which is heated by cooling the fuel cell is introduced in the heat exchanger to be heat-exchanged with air. The cooling water having temperature lowered through the heat exchange is returned to a cooling water circuit for the fuel cell, and the air having temperature raised through the heat exchange heats the hydrogen occluding alloy container.

Further, there is also known a compression-type storage method of storing, at high pressure, oxygen to be consumed in the fuel cell in an oxygen container. This is adopted for a fuel cell used in an environment in which oxygen is thin or no oxygen exists, for example, in water, a tunnel filled with an exhaust gas, or the like.

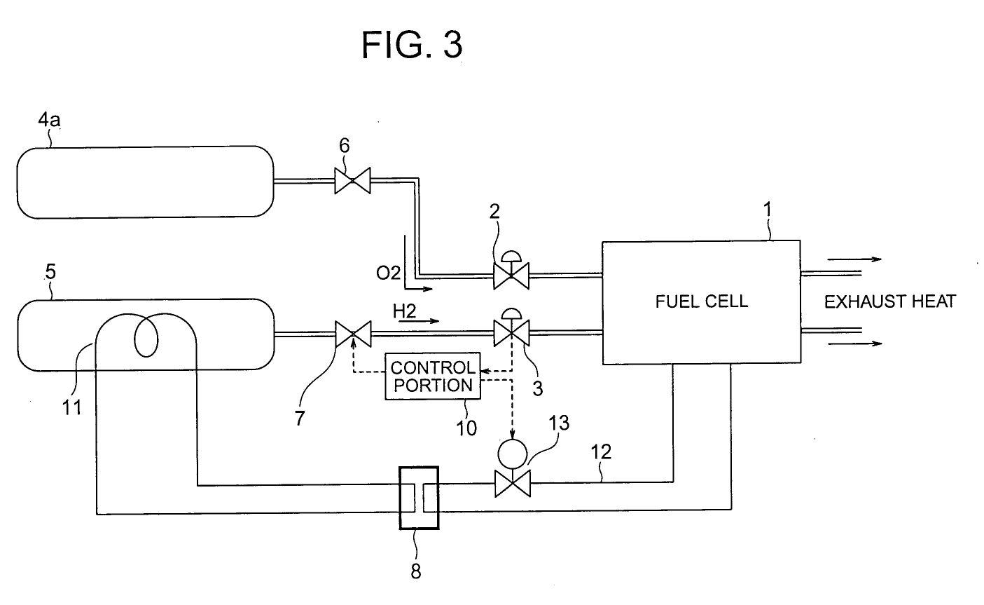

FIG. 3 shows a fuel cell structured by simply combining those. A fuel cell 1 is connected to an oxygen supply device 4a through a first pressure control valve 2 and a first opening/closing valve 6 in the stated order, and is connected to a hydrogen occluding alloy container 5 through a second pressure control valve 3 and a second opening/closing valve 7 in the stated order. The oxygen supply device 4a is of a compression-type and stores an oxygen gas in the oxygen container at high pressure.

The hydrogen occluding alloy container 5 is provided with a hydrogen heating means 11a. The hydrogen heating means 11a is brought into contact with an exhaust heat obtained after cooling the fuel cell 1 through a closed circuit 12 including a temperature regulating valve 13 and a heat exchanger 8, and a heating medium for performing heat exchange in the heat exchanger 8 is guided by the hydrogen heating means 11a to heat the hydrogen occluding alloy container 5 and thus a hydrogen occluding alloy. Opening/closing of each of the valves 2, 3, 6, 7, and 13 are controlled by a control portion 10.

In the fuel cell operating apparatus, by opening the valves 2, 3, 6, 7, and 13, a heating medium for performing heat exchange in the heat exchanger 8 heats the hydrogen occluding alloy container 5 to cause pressure to rise. Then, hydrogen is supplied into the fuel cell 1 and oxygen from the oxygen supply device 4a is supplied thereinto, thereby operating the fuel cell 1.

### Patent Document 1: JP 05-29015 A

### Patent Document 2: JP 2002-252008 A

### DISCLOSURE OF THE INVENTION

### Problems to be Solved by the Invention

There is a problem in that a gas pressure in the oxygen container of the oxygen supply device 4a is high, thereby causing amounting cost for charging gas into the oxygen container. Further, there is also a problem in terms of safety at a time of operation and storage. In particular, in a case where an operating time of the fuel cell 1 is elongated, it is required to increase an amount of stored oxygen. That is, increase in gas pressure and/or increase in size of a storage container is necessary, thereby making problems of development/manufacturing cost and safety ensuring of a compact oxygen container conspicuous.

Further, the gas pressure in the oxygen container of the oxygen supply device 4a should be higher than a predetermined gas pressure required for supply to the fuel cell 1. When the pressure becomes lower than a predetermined value as an oxygen gas is consumed, oxygen cannot be supplied to the fuel cell 1, so a great amount of virgin oxygen remains in the oxygen container. Accordingly, only an oxygen gas having higher pressure than the predetermined gas pressure can be used as a fuel, thereby yielding a great amount of virgin oxygen.

The present invention has been made in view of such the conventional technical problem. The oxygen supply device is replaced with one for charging into an oxygen storage container a material superior in oxygen adsorption capacity, and such an adsorbing material is allowed to adsorb the oxygen gas, thereby realizing reduction in pressure and increase in capacity of the oxygen storage container as compared to the compression-type storage method. Further, it is an object to provide a fuel cell operating method and an apparatus for the same using a hydrogen occluding alloy and an oxygen adsorbing material in which, by heating the oxygen storage container as required, supply of the oxygen gas which is stable for a longer period and involves no wasting as compared with conventional ones, thereby making it possible to operate the fuel cell for a longer time.

### Means for Solving the Problems

A structure of the present invention is described below.

An invention according to claim 1 is a fuel cell operating method, including a fuel cell 1, of operating the fuel cell 1 by using hydrogen from a hydrogen resource and oxygen from an oxygen resource as fuels, characterized in that: as the hydrogen resource, a hydrogen occluding alloy container 5 containing a hydrogen occluding alloy which occludes the hydrogen is used; as the oxygen resource, an oxygen storage container 4b containing an oxygen adsorbing material 23 which adsorbs the oxygen is used, the fuel cell operating method including a hydrogen heating means 11a for heating the hydrogen occluding alloy container 5 and an oxygen heating means 11b for heating the oxygen storage container 4b; and the hydrogen occluding alloy container 5 is heated by the hydrogen heating means 11a and excess exhaust heat obtained after the hydrogen occluded in the hydrogen occluding alloy is emitted is guided to the oxygen heating means 11b to heat the oxygen storage container 4b, thereby promoting removal of the oxygen from the oxygen adsorbing material 23 and allowing a pressure of an oxygen gas to rise to supply the hydrogen and the oxygen to the fuel cell 1.

An invention according to claim 2 is the fuel cell operating method according to claim 1, characterized in that a heating medium supplied to the hydrogen heating means 11a and the oxygen heating means 11b has temperature raised by exhaust heat generated from the fuel cell 1.

An invention according to claim 3 is the fuel cell operating method according to claim 1 or 2, characterized by including bypass passages 35, 40 and 40, 36 capable of being switched therebetween to the hydrogen heating means 11a or the oxygen heating means 11b so that only one of the hydrogen occluding alloy container 5 and the oxygen storage container 4b can be heated.

An invention according to claim 4 is the fuel cell operating method according to any one of claims 1, 2, and 3 characterized in that the oxygen adsorbing material 23 is a carbon-based material.

An invention according to claim 5 is a fuel cell operating apparatus, including a fuel cell 1, for operating the fuel cell 1 by using hydrogen from a hydrogen resource and oxygen from an oxygen resource as fuels, characterized in that: as the hydrogen resource, a hydrogen occluding alloy container 5 containing a hydrogen occluding alloy which occludes the hydrogen is used, and as the oxygen resource, an oxygen storage container 4b containing an oxygen adsorbing material 23 which adsorbs the oxygen is used, the fuel cell operating apparatus including a hydrogen heating means 11a for heating the hydrogen occluding alloy container 5 and an oxygen heating means 11b for heating the oxygen storage container 4b; and the hydrogen occluding alloy container 5 is heated by the hydrogen heating means 11a and excess exhaust heat obtained after the hydrogen occluded in the hydrogen occluding alloy is emitted is guided to the oxygen heating means 11b to heat the oxygen storage container 4b, thereby promoting removal of the oxygen from the oxygen adsorbing material 23 and allowing a pressure of an oxygen gas to rise to supply the hydrogen and the oxygen to the fuel cell 1.

### EFFECT OF THE INVENTION

According to independent claims 1 and 5, oxygen is stored in an oxygen adsorbing material contained in the oxygen storage container 4b, so it is possible to markedly increase an amount of gas stored at a limit pressure of the oxygen storage container. Therefore, it is possible not only to reduce costs of developing/manufacturing the oxygen storage container and of charging gas into the oxygen storage container, but also to impart a remarkable effect in which safety at a time of operation is markedly increased. In addition, as compared to a case where oxygen is compressed to be stored at a high pressure, an amount of unused oxygen can be notably lowered with respect to an amount of oxygen stored.

According to claim 2, the exhaust heat generated from the fuel cell 1 is effectively used to reduce an operation cost of the fuel cell.

According to claim 3, hydrogen and oxygen can be appropriately and efficiently supplied to the fuel cell.

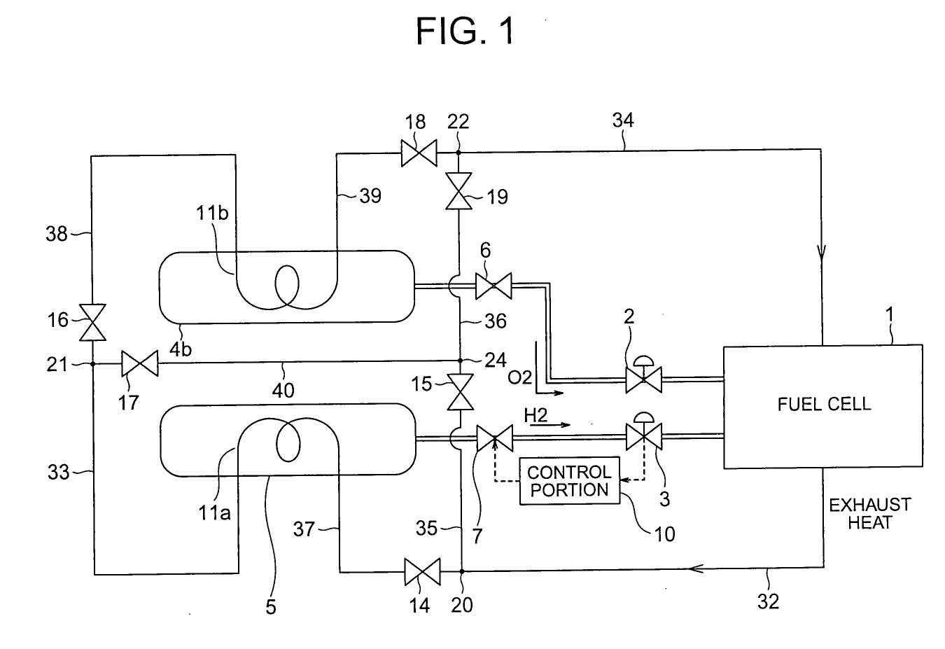

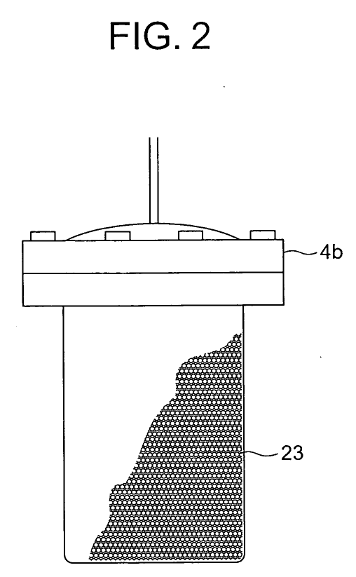

### BRIEF DESCRIPTION OF THE DRAWINGS

[FIG. 1] An arrangement drawing showing a fuel cell operating apparatus according to an embodiment of the present invention.

[FIG. 2] A sectional view showing a part of an oxygen storage container of the same.

[FIG. 3] An arrangement diagram showing a conventional fuel cell operating apparatus.

### BEST MODE FOR CARRYING OUT THE INVENTION

FIGS. 1 and 2 show an embodiment of a fuel cell operating apparatus according to the present invention. In FIG. 1, reference numeral 1 denotes a fuel cell 1. The fuel cell 1 is connected to an oxygen storage container 4b of an adsorption type serving as an oxygen source through a first pressure regulating valve 2 and a first supply opening/closing valve 6 in the stated order, and is also connected to a hydrogen occluding alloy container 5 serving as a hydrogen source through a second pressure regulating valve 3 and a second supply opening/closing valve 7 in the stated order.

As shown in FIG. 3, the oxygen storage container 4b is structured by charging an adsorbing material 23 (carbon-based oxygen adsorbing material) which has a high oxygen adsorption capacity in a high-pressure container. The adsorbing material is desirably a carbon-based material a constituting resource of which is abundant and which is light, for example, an activated carbon, an activated carbon fiber, and a nano carbon material are suitable. However, as a matter of course, other adsorbing materials may also be used. The adsorbing material 23 may be formed in powders, fibers, granules, or pellets, but a form having an adsorbing amount per unit volume as large as possible is preferable. A form of a high pressure container is also not particularly limited, for example, the form may be cylindrical, spherical, or pipe-like. With use of such the adsorption type oxygen storage container 4b, as compared to a conventional example, it is possible to markedly increase an amount of stored gas at the same limit pressure, so the same amount or more amount of gas can be stored even at a low pressure.

Further, the hydrogen occluding alloy container 5 is provided with a tubular hydrogen heating means 11a, and the oxygen storage container 4b is provided with a tubular oxygen heating means 11b. An inlet of the hydrogen heating means 11a is connected to a cooling water outlet of the fuel cell 1. Through a circuit 32 extending to a connection point 20 and a circuit 37 including a flow rate control valve 14, a heating medium from the fuel cell 1 is guided to the hydrogen heating means 11a to heat the hydrogen occluding alloy container 5 and thus a hydrogen occluding alloy accommodated therein. An outlet of the hydrogen heating means 11a is connected to an inlet of the oxygen heating means 11b through a circuit 33 extending to a connection point 21, and a circuit 38 including a flow rate control valve 16. An outlet of the oxygen heating means 11b is connected to a cooling water inlet of the fuel cell 1 through a circuit 39 including a flow rate control valve 18 and extending to a connection point 22, and a circuit 34. The adsorbing material 23 of the oxygen storage container 4b often has hysteresis at a time of adsorption and detachment, and an oxygen molecule becomes difficult to be detached, or a gas pressure after the detachment often does not rise. In such the cases, the oxygen storage container 4b is heated, thereby making it possible to promote the detachment of an oxygen gas and raise the gas pressure.

As described above, by opening the valves 14, 16, and 18, the exhaust heat obtained after cooling the fuel cell 1 is guided to the hydrogen heating means 11a through the circuits 32 and 37 to heat the hydrogen occluding alloy container 5 to allow hydrogen to be emitted from the hydrogen occluding alloy and raise a pressure of a hydrogen gas. After that, an excess exhaust heat thereof is guided to the oxygen heating means 11b through the circuits 33 and 38 to heat the oxygen storage container 4b, promote the detachment of oxygen from the oxygen adsorbing material 23, and raise a pressure of an oxygen gas. As a result, it is possible to supply hydrogen and oxygen to the fuel cell 1 at a predetermined pressure. The heating medium flowing out from the oxygen heating means 11b returns to the fuel cell 1 through the circuits 39 and 34, and contributes to cooling while circulating. The heating medium supplied to the hydrogen heating means 11a and the oxygen heating means 11b has temperature raised by the exhaust heat generated from the fuel cell 1, so the fuel cell 1 constitutes means for supplying a heating medium having high temperature.

Further, the connection point 20 of the circuits 32 and 37 is connected to the connection point 22 of the circuits 34 and 39 through a circuit 35 including a flow rate control valve 15 and a circuit 36 including a flow rate control valve 19. Accordingly, the heating medium is allowed to circulate from the fuel cell 1 without passing through the hydrogen heating means 11a and the oxygen heating means 11b to be allowed to flow into the fuel cell 1 again, thereby performing a cooling operation.

Still further, a connection point 24 of both the circuits 35 and 36 is connected to the connection point 21 of the circuits 33 and 38 through a circuit 40 including a flow rate control valve 17.

The circuits 35 and 40 are provided so as to bypass the hydrogen occluding alloy container 5 to constitute a bypass passage which enables heating of only the oxygen heating means 11b. That is, the circuits 32, 35, 40, 38, 39, and 34 are connected through switching, thereby making it possible to heat only the oxygen storage container 4b. On the other hand, the circuits 40 and 36 are provided so as to bypass the oxygen storage container 4b to constitute a bypass passage which enables heating of only the hydrogen heating means 11a. That is, the circuits 32, 37, 33, 40, 36, and 34 are connected through switching, thereby making it possible to heat only the hydrogen occluding alloy container 5.

As a matter of fact, opening/closing operations of the valves 14 to 19 are controlled by the control portion 10. Note that, the valves 14 and 15 may be formed of a single three-way changeover valve, the valves 16 and 17 may be formed of a single three-way changeover valve, and the valves 18 and 19 may be formed of a single three-way changeover valve. Further, opening/closing operations of the first pressure regulating valve 2, the second pressure regulating valve 3, the first supply opening/closing valve 6, and the second supply opening/closing valve 7 are controlled by the control portion 10 having a program stored therein in advance.

Next, effects will be described.

In the fuel cell operating apparatus, when the valves 14, 16, and 18 are opened in a state where the first and second supply opening/closing valves 6 and 7 are opened and the fuel cell 1 is operated, the heating medium heated while being used for cooling in the fuel cell 1 is supplied to the hydrogen heating means 11a and the oxygen heating means 11b in the stated order. First, the heating medium heated through the heat exchange in the fuel cell 1 heats the hydrogen occluding alloy container 5, thereby causing hydrogen to be emitted from the hydrogen occluding alloy. Then, the pressure rises, and hydrogen is supplied to a fuel electrode of the fuel cell 1.

Next, the heating medium which has passed through the hydrogen heating means 11a, that is, an excess exhaust heat heats the oxygen supply device 4a, thereby causing oxygen to be removed from the oxygen adsorbing material 23 of the oxygen supply device 4a, and then, the pressure rises. As a result, by using the hydrogen and the oxygen as fuels which have undergone a pressure control through both the first pressure regulating valve 2 and the first opening/closing valve 6, the fuel cell 1 is operated.

That is, heat generated when the fuel cell 1 generates electricity through reception of a fuel gas supplied from the hydrogen occluding alloy container 5 and the oxygen storage container 4b is absorbed by the heating medium through a cooling plate. The exhaust heat thereof is allowed to circulate through the hydrogen heating means 11a, the oxygen heating means 11b, the circuits 32 and 34, and the like to be cooled, thereby being removed. The heating medium which is cooled passes through the cooling plate, thereby keeping an operating temperature of the fuel cell 1. Hydrogen and oxygen required by the fuel cell 1 is sometimes used at a relatively high pressure in order to raise an electrical efficiency. In such the case, particularly, it is required to heat the hydrogen occluding alloy container 5 or the oxygen storage container 4b to raise a hydrogen pressure or an oxygen pressure.

An amount of heat absorbed when the hydrogen occluding alloy emits hydrogen is about 24 to 65 KJ/mol·H₂. On the other hand, an amount of heat required by a carbon-based material having a high oxygen adsorption capacity is about 6 to 22 KJ/mol·O₂ which is smaller than that of the hydrogen occluding alloy, and in many cases, less than a half thereof. Further, oxygen molecules are physically adsorbed by an adsorbing material, so an oxygen gas is generated more easily than a hydrogen gas.

Accordingly, the oxygen storage container 4b is provided on a downstream side of the hydrogen occluding alloy container 5. The excess exhaust heat obtained after heating the hydrogen occluding alloy container 5 is used to heat the oxygen storage container 4b of an adsorption type to promote removal of oxygen from the oxygen adsorbing material 23 and to raise the pressure of the oxygen gas in the oxygen storage container 4b, thereby supplying the oxygen gas to an air electrode of the fuel cell 1. Both fuel gases emitted/removed at an appropriate pressure from the oxygen storage container 4b and the hydrogen occluding alloy container 5 by heating the container are controlled by the pressure regulating valves 2 and 3 so as to be at appropriate supply pressures with respect to the fuel cell 1. Note that, it is possible to open the flow rate control valves 15 and 19 as appropriate, and guide a part of the heating medium after cooling the fuel cell 2 supplied from the circuit 32 to the circuits 35, 36, and 34, to thereby adjust a thermal dose with respect to the hydrogen occluding alloy container 5 and the oxygen storage container 4b.

Further, when the flow rate control valve 14 is closed and the flow rate control valves 15 and 17 are opened, the heating medium is allowed to pass through the circuits 35, 40 (and further through 38, 39, and 34) while bypassing the hydrogen occluding alloy container 5, thereby enabling heating only by the oxygen heating means 11b. On the other hand, when the flow rate control valves 16 and 18 are closed and the flow rate control valves 17 and 19 are opened, the heating medium is allowed to pass through the circuits 40, 36 (and further through 34) while bypassing the oxygen storage container 4b, thereby enabling heating only by the hydrogen heating means 11a.

Still further, the flow rate in the flow rate control valve 14 is controlled to be small and the flow rate control valves 15 and 17 are opened to allow the heating medium to pass through the circuits 35 and 40 as well, thereby making it possible to perform heating by the oxygen heating means 11b with a large amount of heat as compared to the hydrogen occluding alloy container 5. On the other hand, the flow rate in the flow rate control valve 16 is controlled to be small and the flow rate control valves 17 and 19 are opened to allow the heating medium to pass through the circuits 40 and 36 as well, thereby making it possible to perform heating by the hydrogen heating means 11a with a large amount of heat as compared to the oxygen storage container 4b.

As a matter of course, the flow rate control valves 14, 17, and 18 are closed and the flow rate control valves 15 and 19 are opened to allow the heating medium to pass through the circuits 32, 35, 36, and 34 while bypassing both the hydrogen occluding alloy container 5 and the oxygen storage container 4b, thereby making it possible to interrupt heating by the hydrogen heating means 11a and the oxygen heating means 11b and return the heating medium to the fuel cell 1. The circuits 35 and 36 constitute a bypass passage bypassing both the hydrogen occluding alloy container 5 and the oxygen storage container 4b.

Such the operations deal with needs for individually adjusting the gas pressure according to a consumption amount of gases and a remaining amount of gases in the oxygen storage container 4b and the hydrogen occluding alloy container 5. As a result, a hydrogen gas and an oxygen gas can be appropriately supplied to the fuel cell 1 while suppressing an abnormal rise of an internal pressure of the oxygen storage container 4b and the hydrogen occluding alloy container 5. Adjustment of a degree of opening of each of the flow rate control valves 14 to 19, that is, flow rate adjustment can be accurately performed with reference to detected values on pressure gauges (not shown) provided to the oxygen storage container 4b and the hydrogen occluding alloy container 5.

While in the above-mentioned embodiment, the heating medium used for cooling the fuel cell 1 is flowed directly through the hydrogen heating means 11a or the oxygen heating means 11b, it is also possible to obtain the same effects by, as shown in FIG. 3, allowing the heating medium heated through the heat exchanger to circulate through the hydrogen heating means 11a or the oxygen heating means 11b. It is also possible to obtain the same effects by allowing a hot heating medium other than the heating medium used for cooling the fuel cell 1 to circulate through the hydrogen heating means 11a or the oxygen heating means 11b.

1. A fuel cell operating method, comprising a fuel cell (1), of operating a fuel cell (1) by using hydrogen from a hydrogen resource and oxygen from an oxygen resource as fuels, wherein:
a hydrogen occluding alloy container (5) containing a hydrogen occluding alloy which occludes the hydrogen is used as the hydrogen resource;
an oxygen storage container (4b) containing an oxygen adsorbing material (23) which adsorbs the oxygen is used as the oxygen resource, the fuel cell operating method including a hydrogen heating means (11a) for heating the hydrogen occluding alloy container (5) and an oxygen heating means (11b) for heating the oxygen storage container (4b); and
the hydrogen occluding alloy container (5) is heated by the hydrogen heating means (11a) and an excess exhaust heat obtained after the hydrogen occluded in the hydrogen occluding alloy is emitted is guided to the oxygen heating means (11b) to heat the oxygen storage container (4b), thereby promoting removal of the oxygen from the oxygen adsorbing material (23) and allowing a pressure of an oxygen gas to rise to supply the hydrogen and the oxygen to the fuel cell (1).

2. The fuel cell operating method according to claim 1, wherein a heating medium supplied to the hydrogen heating means (11a) and the oxygen heating means (11b) has temperature raised by an exhaust heat generated from the fuel cell (1).

3. The fuel cell operating method according to claim 1, wherein comprising bypass passages (35, 40 and 40, 36) capable of being switched therebetween to the hydrogen heating means (11a) or the oxygen heating means (11b) so that only one of hydrogen occluding alloy container (5) and the oxygen storage container (4b) can be heated.

4. The fuel cell operating method according to claim 1, wherein the oxygen adsorbing material (23) is a carbon-based material.

5. A fuel cell operating apparatus, comprising a fuel cell (1), for operating a fuel cell (1) by using hydrogen from a hydrogen resource and oxygen from an oxygen resource as fuels, wherein:
a hydrogen occluding alloy container (5) containing a hydrogen occluding alloy which occludes the hydrogen is used as the hydrogen resource, and as the oxygen resource, an oxygen storage container (4b) containing an oxygen adsorbing material (23) that adsorbs the oxygen is used, the fuel cell operating apparatus including a hydrogen heating means (11a) for heating the hydrogen occluding alloy container (5) and an oxygen heating means (11b) for heating the oxygen storage container (4b); and
the hydrogen occluding alloy container (5) is heated by the hydrogen heating means (11a) and an excess exhaust heat obtained after the hydrogen occluded in the hydrogen occluding alloy is emitted is guided to the oxygen heating means (11b) to heat the oxygen storage container (4b), thereby promoting removal of the oxygen from the oxygen adsorbing material (23) and allowing a pressure of an oxygen gas to rise to supply the hydrogen and the oxygen to the fuel cell (1).

6. The fuel cell operating method according to claim 2, wherein comprising bypass passages (35, 40 and 40, 36) capable of being switched therebetween to the hydrogen heating means (11a) or the oxygen heating means (11b) so that only one of hydrogen occluding alloy container (5) and the oxygen storage container (4b) can be heated.

7. The fuel cell operating method according to claim 2, wherein the oxygen adsorbing material (23) is a carbon-based material.

8. The fuel cell operating method according to claim 3, wherein the oxygen adsorbing material (23) is a carbon-based material.
